(19) United States
(12) Patent Application Publication
(10) Pub. No.: US 2013/0295230 A1
(43) Pub. Date: Nov. 7, 2013

(54) SUGAR-FREE NATURALLY PRESERVED STEVIA SUPPLEMENT

(71) Applicant: Nyangenya Maniga, Gilbert, AZ (US)

(72) Inventor: Nyangenya Maniga, Gilbert, AZ (US)

(73) Assignee: NUTRACEUTICAL CORPORATION, Park City, UT (US)

(21) Appl. No.: 13/542,448

(22) Filed: Jul. 5, 2012

Related U.S. Application Data
(60) Provisional application No. 61/643,188, filed on May 4, 2012.

(51) Int. Cl. A23L 1/221

(52) U.S. Cl. CPC A23L 1/221
USPC 426/72; 426/532

(57) ABSTRACT

A stevia supplement that is preserved with natural ingredients (e.g., natural vinegar, polyene macrolide, such as natamycin, and/or citric acid) optionally having a balanced smell and/or flavor profile is provided.

### CROSS-REFERENCE TO RELATED APPLICATIONS

This application claims the benefit of U.S. Provisional Application No. 61/643,188, filed May 4, 2012, which is hereby incorporated by reference herein in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### STATEMENT REGARDING FEDERALLY SPONSORED RESEARCH OR DEVELOPMENT

Not Applicable,

### BACKGROUND

The disclosure relates generally to a naturally preserved stevia supplement (e.g., in liquid, beverage or other form) that may have a flavor profile that masks the undesirable after-taste or the undesirable smell of stevia or one that masks both. The disclosure relates more particularly, but not necessarily entirely, to an improved naturally preserved stevia supplement that is naturally preserved and has a stable shelf-life of at least two years.

An embodiment of the disclosure is directed to a sugar-free naturally preserved stevia supplement having a desirable flavor profile that is also free of synthetic preservatives. According to another embodiment of the disclosure, the stevia supplement may only contain natural ingredients as opposed to ingredients that are considered synthetically derived. The stevia supplement may he used as an alternative way to provide a sweet taste without using sugar. However, stevia is about 300 times sweeter than conventional sugar. Thus, while very small amounts of stevia are needed to provide the same amount of sweetness provided by table sugar, stevia itself has a bitter after-taste and/or smell that is/are undesirable. Accordingly, before a suitable stevia supplement may be considered acceptable to the public at large or to a sub-group of the same. It is sometimes desirable to overcome the bitter after-taste (and other undesirable flavor characteristics of stevia) and undesirable smell attributes of stevia while providing a desirable degree of preservative action with only natural ingredients (i.e. without using non-natural ingredients and/or synthetic preservatives).

Stevia has been recognized as a sweetener by the indigenous natives of South America for many years. It has been recognized that stevia may have potential use as a sweetener in place of natural sugar (e.g., sugar obtained and refined from sugar cane or other sugar sources). Thus, stevia has potential applications for use as a sugar substitute or at least as a stevia supplement that is sugar-free.

Also, the sweetness of stevia is about 300 times more than that of an equivalent amount of natural sugar. Therefore, only minute amounts of stevia would need to be used to impart the same degree of sweetness as would a much larger amount of natural sugar.

Many consumers prefer natural products that are free of synthetic ingredients. Therefore, it becomes important to provide a stevia supplement that contains only natural ingredients, but that still tastes and smells good and does not spoil easily. It is desirable to provide a stevia supplement that contains only natural ingredients that tastes and smells good to a user and has the requisite preservative properties so as not to spoil readily.

A description of stevia is provided in U.S. Pat. No. 7,267,835 ('835 patent). See the '835 patent from col. 4, line 6 to col. 7, line 8 for a detailed description of stevia. Note the formation of stevia extract by removing non-sweet components from the extract, such as ionic impurities, using various solvents, including hydrous methanol or hydrous ethanol. Also, stevia contains various components. For example, the HPLC (high pressure liquid chromatograph) illustrated in FIG. 1, illustrates the various components of stevia as disclosed in the '835 patent.

U.S. Patent Application Publication No. 2007/0128311 ('311 application) also describes stevia. Yet another patent application that describes stevia is U.S. Patent Application Publication No. 2007/0275140 ('140 application). The '835 patent, the '311 application and the '140 application are each incorporated herein by this reference.

Thus, in view of the above noted consumer demand for “natural” products, pursuant to one or more embodiments of a desirable stevia supplement, such stevia supplement(s) sought should taste good, smell good and still be adequately preserved using only natural ingredients.

### BRIEF DESCRIPTION OF THE DRAWINGS

The features and advantages of the disclosure will become apparent from a consideration of the subsequent detailed description presented in connection with the accompanying drawings in which:

FIG. 1 is a high pressure liquid chromatograph (HPLC), illustrating the various components of stevia.

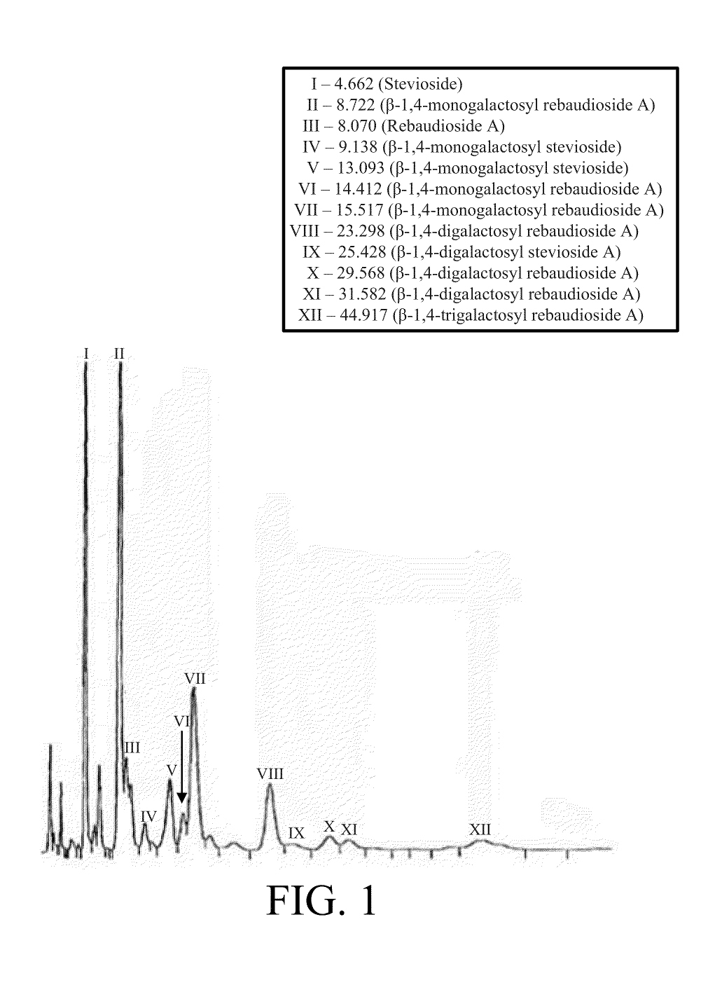

### DETAILED DESCRIPTION

For the purposes of promoting an understanding of the principles in accordance with the disclosure, reference will now be made to one or embodiments, some of which are illustrated in the drawings, and specific language will be used to describe the same. It will nevertheless be understood that no limitation of the scope of the disclosure is thereby intended. Any alterations and further modifications of the inventive features described and illustrated herein, and any additional applications of the principles of the disclosure as described and illustrated herein, which would normally occur to one skilled in the relevant art and having possession of this disclosure, are to be considered within the scope of the disclosure claimed.

Before the compositions and methods for an improved sugar-free naturally preserved stevia supplement are disclosed and described, it is to be understood that this disclosure is not limited to the particular ingredients, configurations, process steps, and materials disclosed herein as such ingredients, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified ingredients, materials or steps and those that do not materially affect the basic and novel characteristic or characteristics of the claimed disclosure.

According to one or more embodiments of the disclosure, a stevia supplement may include a combination of all or some, but not all, of the following ingredients (as further noted in the detailed description) to naturally preserve the stevia supplement:

(a) stevia (e.g., stevia stock solution made from stevia extract powder with 90% stevia and with at least 40% rebaudioside such as that obtained from Wisdom Naturals LLC, Gilbert Arizona);

(b) water (e.g., de-ionized water or other potable water source such as distilled water);

(c) water soluble natural additive(s) (optional);

(d) vinegar (e.g., white vinegar with 5% acidity—Heinz® brand from Fry's Supermarket);

(e) citric acid (e.g., optional extract from citrus);

(f) polylysine; and

(g) a polyene macrolide selected from the group consisting of amphotericin B, nystatin, natamycin, and filipin.

An illustrative non-limiting example of a stock solution of stevia (that may be used) may be prepared according to the following ingredients listed in Table I below:

TABLE I
Stock Stevia Solution (One Embodiment)

| Ingredient(s) | % by Weight |
|---|---|
| De-ionized water | 82.5 |
| Stevia extract powder with 90% stevia (40% | 17.5 |
| Rebaudioside) | |
| Total | 100 |

The stock stevia solution may be made using stevia powder obtained from Wisdom Naturals, LLC, Gilbert Ariz. or other raw material suppliers of stevia.

With respect to the stock stevia solution of ingredient (a) noted above (see Summary) for example, the stevia extract powder with 90% stevia (with at least 40% rebaudioside) refers to the percent by weight of the stevia extract based on a total weight of the powder itself. Additionally, the 40% rebaudioside refers to the percent by weight of the rebaudioside based on the total weight of the powder itself.

The stock stevia solution may be formed with de-ionized water (or distilled water) to avoid introducing undesirable contaminants, undesirable microbials, and/or undesirable metals such as calcium (Ca) and zinc (Zn) into the stevia stock solution or ultimately into the final stevia supplement formed therewith.

Other embodiments of the stock stevia solution that may be used may contain stevia in concentrations (% w/w) as follows:
(stock a1) from about 0.0001% to about a saturated solution of stevia (e.g., in de-ionized water or distilled water);
(stock a2) from about 0.001% to about a saturated solution of stevia (e.g., in de-ionized water or distilled water):
(stock a3) from about 0.01% to about a saturated solution of stevia (e.g., in de-ionized water or distilled water);
(stock a4) from about 0.1% to about a saturated solution of stevia (e.g., in de-ionized water or distilled water);
(stock a5) from about 1% to about a saturated solution of stevia (e.g., in de-ionized water or distilled water);
(stock a6) from about 2% to about 50% solution of stevia (e.g., in de-ionized water or distilled water);
(stock a7) from about 3% to about 40% solution of stevia (e.g., in de-ionized water or distilled water);
(stock a8) from about 4% to about 30% solution of stevia (e.g., in de-ionized water or distilled water);
(stock a9) from about 5% to about 20% solution of stevia (e.g., in de-ionized water or distilled water);
(stock a10) from about 5% to about 19% solution of stevia (e.g., in de-ionized water or distilled water);
(stock a11) from about 5% to about 18% solution of stevia (e.g., in de-ionized water or distilled water);
(stock a12) from about 5% to about 17% or about 17.5% solution of stevia (e.g., in de-ionized water or distilled water);
(stock a13) from about 5% to about 16% solution of stevia (e.g., in de-ionized water or distilled water);
(stock a14) from about 5% to about 15% solution of stevia (e.g., in de-ionized water or distilled water);
(stock a15) from about 5% to about 14% solution of stevia (e.g., in de-ionized water or distilled water);
(stock a16) from about 5% to about 13% solution of stevia (e.g., in de-ionized water or distilled water);
(stock a17) from about 5% to about 12% solution of stevia (e.g., in de-ionized water or distilled water);
(stock a18) from about 5% to about 11% solution of stevia (e.g., in de-ionized water or distilled water);
(stock a19) from about 5% to about 10% solution of stevia (e.g., in de-ionized water or distilled water);
(stock a20) from about 1% to about 20% solution of stevia (e.g., in de-ionized water or distilled water);
(stock a21) from about 1% to about 19% solution of stevia (e.g., in de-ionized water or distilled water);
(stock a22) from about 1% to about 18% solution of stevia (e.g., in de-ionized water or distilled water);
(stock a23) from about 1% to about 17% or about 17.5% solution of stevia (e.g., in de-ionized water or distilled water);
(stock a24) from about 1% to about 16% solution of stevia (e.g., in de-ionized water or distilled water):
(stock a25) from about 1% to about 15% solution of stevia (e.g., in de-ionized water or distilled water);
(stock a26) from about 1% to about 14% solution of stevia (e.g., in de-ionized water or distilled water);
(stock a27) from about 1% to about 13% solution of stevia (e.g., in de-ionized water or distilled water);
(stock a28) from about 1% to about 12% solution of stevia (e.g., in de-ionized water or distilled water);
(stock a29) from about 1% to about 11% solution of stevia (e.g., in de-ionized water or, distilled water);
(stock a30) from about 1% to about 10% solution of stevia (e.g., in de-ionized water or distilled water); and
(stock a31) each of the above noted ranges restated with the term “about” deleted in both instances within any given range identified individually under items (stock a1) to (stock a30).

However in one or more embodiments of the final stevia supplement, the amount of the stock stevia solution itself may vary so long as the desired flavor, smell and/or preservative action is/are obtained. In certain embodiments of the final stevia supplement, the desired smell profile and the desired preservative action are obtained. Thus, in certain non-limiting illustrative examples, the amount(s) of stock stevia solution (as described in Table 1 above) used to form the final stevia supplement may be as follows (based on a total weight of the final stevia supplement made):
(aa1) from about 0.0001% to about 70% of stock stevia solution (of Table I);
(aa2) from about 0.001% to about 65% of stock stevia solution (of Table I);
(aa3) from about 0.01% to about 60% of stock stevia solution (of Table I);
(aa4) from about 0.1% to about 55% of stock stevia solution (of Table I);
(aa5) from about 1% to about 50% of stock stevia solution (of Table I);
(aa6) from about 2% to about 50% of stock stevia solution (of Table I);
(aa7) from about 3% to about 45% of stock stevia solution (of Table I);
(aa8) from about 5% to about 40% of stock stevia solution (of Table I);
(aa9) from about 5% to about 30% of stock stevia solution (of Table I);
(aa10) from about 5%) to about 20% of stock stevia solution (of Table I);
(aa11) from about 5% to about 18% of stock stevia solution (of Table I);
(aa12) from about 5% to about 17% or 17.5% of stock stevia solution (of Table I);
(aa13) from about 5% to about 15% of stock stevia solution (of Table I);
(aa14) from about 15% to about 40% of stock stevia solution (of Table I);
(aa15) from about 15% to about 30% of stock stevia solution (of Table I);
(aa16) from about 15% to about 20% of stock stevia solution (of Table I);
(aa17) from about 15% to about 19% of the stock stevia solution (of Table I);
(aa18) from about 15% to about 18% of the stock stevia solution (of Table I);
(aa19) from about 15% to about 17.5% of the stock stevia solution (of Table I);
(aa20) from about 15% to about 17% of the stock stevia solution (of Table 1); and
(aa21) each of the above noted ranges restated with the term “about” deleted in both instances within any given range identified individually under items (aa1) to (aa20).

With respect to ingredient (d) noted above (see Summary) for example, the amount of the vinegar (5% acidity) that may be included in the final stevia supplement is based on a percent by weight of the total weight of the final stevia supplement described herein.

A non-limiting example of vinegar (acidity 5%) that may be used is Heinz® brand distilled white vinegar (with 5% acidity) available from various supermarkets, including Fry's supermarket in the United States, Another non-limiting example of vinegar (acidity 5%) that may be used is Heinz® brand distilled apple cider vinegar (with 5% acidity) available from various supermarkets, including Fry's supermarket in the United States. In some embodiments, the distilled form of the vinegar may be used. In one or more embodiments, the pasteurized form of the vinegar may be used due to its greater resistance to microbial growth and spoilage. Also the vinegar used may be filtered to remove undesirable particulate matter as well. Certainly, vinegar that is filtered, distilled, and pasteurized may be used according to one or more embodiments of the final stevia supplement described herein.

Preservation of a stevia supplement (e.g. a stevia concentrate or a stock stevia solution to which are added various ingredients to form the final stevia supplement) is important to protect against potentially harmful or undesirable microbial growth. While conventional food preservatives may be used, many health conscious consumers prefer supplements containing only natural ingredients.

Synthetic preservatives (e.g., the parabens, etc.) are often listed on product labels together with other ingredients. Also, synthetic preservatives are known to those of ordinary skill in the art of preserving foods and beverages. Often, use of synthetic ingredients including synthetic preservatives precludes (or may preclude) characterizing a product as a “natural” or “all-natural” or “100% natural” product (or some equivalent language indicating that the product is “natural”). Many consumers avoid products containing synthetic or semi-synthetic preservatives and/or other non-natural ingredients for various reasons.

Accordingly, in order to formulate a naturally preserved stevia supplement, ingredients (a)-(e) described above (see Summary) may be combined as further described herein.

According to one or more embodiments with respect to adequate and/or requisite preservative action against potentially harmful or undesirable microbial growth, a naturally preserved stevia supplement contains (or should contain) less than 10 cfu/g (coliform units per gram) of certain bacteria, yeast and mold species after being exposed to the same and at some set time delay post exposure.

For example, test bacteria, test yeast and test mold species to which one or more embodiments of a stevia supplement may be exposed include (but may not be limited to) Staphylococcus Aureus, Pseudomonas Aeruginosa, Escheria Coli, Yeast—Candida Albicans, and Mold—Aspergillus Niger. These species of bacteria, yeast and mold are often used as test microbials to determine if the stevia supplement being tested is properly preserved,

With respect to preserving a stevia supplement containing non-natural ingredients, stevia powder may be dissolved in water and synthetic additives or synthetic preservatives may be added to prevent or resist microbial growth. The so formed stevia stock solution may be formed with de-ionized water or distilled water.

However, if no preservatives or additives were added to the stevia stock solution so formed to inhibit microbial growth, then mold growth is observed to flourish in less than one week in an open container holding the stock stevia solution. Typically, if no preservative is added (whether natural or synthetic), then mold is observed to have grown in 3-4 days and the product takes on a cloudy appearance and ultimately exhibits a cloudy appearance together with a green-black-grey colored hue that is a distinct indication of spoilage.

By contrast, in the preservative added embodiments of the stock stevia solutions used to form the final stevia supplement, even if certain species of bacteria, yeast or molds were added, the preserved version prevents, inhibits and/or resists microbial growth as further explained herein so as not to exceed 10 cfu/g at 14 days and/or at 28 days post exposure to species such as Staphylococcus Aureus, Pseudomonas Aeruginosa, Escheria Coli, Yeast—Candida Albicans, and Mold—Aspergillus Niger. Often, these test microbials may be introduced simultaneously or nearly so such that the time of exposure may be nearly at the same time or within an acceptable variation of the same (e.g., within minutes of one another not to exceed about 10-20 minutes from the first exposure to the last). The inoculum may be introduced in separate test vials or test plates in agreement with test procedures specified in the current version of USP 24 NF Microbial Limit Tests 61 and/or the United States Pharmacopeia general (USP) Chapter 51, Antimicrobial Effectiveness Testing, known to those of ordinary skill in the art.

Also, according to one or more non-limiting embodiments with respect to the requisite preservative action against microbial growth, a stock stevia solution (and/or a final stevia supplement made with the same stock stevia solution) should exhibit a non-detectable level of the microbial species Staphylococcus Aureus, Pseudomonas Aeruginosa, Escheria Coli, Yeast—Candida Albicans, and Mold—Aspergillus Niger at 28 days post exposure to the same species. In such case, the test stock stevia solution (and/or the final stevia supplement tested for microbial growth and made with the stock stevia solution) is/are considered properly preserved if the microbial growth of the species Staphylococcus Aureus, Pseudomonas Aeruginosa, Escheria Coli, Yeast—Candida Albicans, and Mold—Aspergillus Niger is non-detectable. Such non-detectable level of these species may be denoted as n.d. (not detected) or as ≦10 cfu/g in the Examples section of this application.

Such preserved versions (e.g., final stevia supplement) made with preservatives (e.g., natural preservatives) may be provided in 1 oz. aliquots (or in larger aliquots such as in bulk volume quantities) in sealed containers of suitable type (e.g., a can, a pouch, a syringe, a tube, or other disposable container, etc.). Also, such preserved version(s) are designed to maintain the requisite flavor, taste, and/or smell profiles together with the requisite resistance to spoilage acceptable to consumers and safe for ingestion in humans and/or other mammals. Such preserved versions can be formulated with natural ingredients alone—or if desired otherwise, they can be formulated with non-natural ingredients to form certain other embodiments of the final stevia supplement. Certain non-natural preservatives include, but are not limited to, sorbic acid and others listed Remington's Pharmaceutical Sciences (most recently published version for example) and other current pharmaceutical and food grade formulation textbooks and references well known to those of ordinary skill in the art of preserving foods, beverages, supplements and medicines. The latest published version of Remington's Pharmaceutical Sciences is incorporated herein by reference as of the filing date of this application.

The preserved versions of the stevia supplement may also contain chelating agents that chelate metallic ions or chelate ions of calcium and/or zinc.

In certain comparative tests, the preservative robustness of one or more embodiments of the candidate stevia supplement described herein may be determined after being exposed to the foregoing test microbial species for a period of at least 14 or at least 28 days. Adequate preservation of the stevia supplement may be demonstrated when the microbial growth after microbial exposure to an inoculum is below the limits set according to the USP 24 NF test 61, an/or United States Pharmacopeia general (USP) Chapter 51, Antimicrobial Effectiveness Testing, known as the Microbial Limit Test for the each of the species Staphylococcus Aureus, Pseudomonas Aeruginosa, Escheria Coli, Yeast—Candida Albicans, and Mold—Aspergillus Niger). According to certain illustrative and non-limiting embodiments, such limits for each of the species Staphylococcus Aureus, Pseudomonas Aeruginosa, Escheria Coli, Yeast—Candida Albicans, and Mold—Aspergillus Niger may be independently set at less than or equal to 10 cfu/g, less than or equal to 9 cfu/g, less than or equal to 8 cfu/g, less than or equal to 7 cfu/g, less than or equal to 6 cfu/g, less than or equal to 5 cfu/g, less than or equal to 4 cfu/g, less than or equal to 3 cfu/g, less than or equal to 2 cfu/g, or less than or equal to 1 cfu/g, or even at 0 cfu/g, for the tested stevia supplement to he considered suitably preserved for safe human ingestion. The USP 24 NF Microbial Limit Test 61 procedural details are provided in The United States Pharmacopeia (“USP”) (The National Formulary) published by the United States Pharmacopeia Convention, Inc. in Rockville, Md. The procedural details and threshold level details for passing the USP 24 Microbial Limit Test 61, and/or United States Pharmacopeia general (USP) Chapter 51, Antimicrobial Effectiveness Testing, for the species Staphylococcus Aureus, Pseudomonas Aeruginosa, Escheria Coli, Yeast—Candida Albicans, and Mold—Aspergillus Niger are incorporated herein by reference into this application.

Generally however, pursuant to one or more embodiments, if a candidate stevia supplement is exposed to an inoculum of the species Staphylococcus Aureus, Pseudomonas Aeruginosa, Escheria Coli, Yeast—Candida Albicans, and Mold—Aspergillus Niger species and after at least 28 days each of these species is present at <10 cfu/g (i.e., essentially a non-detectable level) post exposure, then such embodiment of the stevia supplement is suitably preserved and considered safe for human ingestion. Any stevia supplement or any stock stevia solution containing more than 10 cfu/g of any of the species Staphylococcus Aureus, Pseudomonas Aeruginosa, Escheria Coli, Yeast—Candida Albicans, and Mold—Aspergillus Niger would still need to adequately pass the USP 24 NF Microbial Limit Test 61 (e.g., a preservative challenge test), and/or United States Pharmacopeia general (USP) Chapter 51, Antimicrobial Effectiveness Testing, to be considered suitably preserved for safe human ingestion. To the extent possible, the presence of any of the above noted microbial species should be below the safe threshold levels suitable for human consumption pursuant to the standards set by the USP NF.

According to one or more embodiments, the levels of the various test microbial at 28 days post exposure to an inoculum dose of the above noted microbial species (Staphylococcus Aureus, Pseudomonas Aeruginosa, Escheria Coli, Yeast—Candida Albicans, and Mold—Aspergillus Niger) may each independently be at less than or equal to 10 cfu/g, less than or equal to 9 cfu/g, less than or equal to 8 cfu/g, less than or equal to 7 cfu/g, less than or equal to 6 cfu/g, less than or equal to 5 cfu/g, less than or equal to 4 cfu/g, less than or equal to 3 cfu/g, less than or equal to 2 cfu/g, less than or equal to 1 cfu/g, or even at 0 cfu/g.

The appropriate inoculum of the species Staphylococcus Aureus, Pseudomonas Aeruginosa, Escheria Coli, Yeast—Candida Albicans, and Mold—Aspergillus Niger is used in accordance with the USP 24 NF Microbial Limit Test 61, and/or United States Pharmacopeia general (USP) Chapter 51, Antimicrobial Effectiveness Testing.

In addition, while providing a desired level of preservative robustness, the natural stevia supplement sought to be prepared (according to one or more embodiments) is one that also may have the appropriate taste, flavor and/or smell profile (e.g., does not exhibit the overly sweet taste of stevia, does not exhibit the bitter after-taste of stevia components, does not exhibit the prolonged after-taste of stevia, does not exhibit the metallic taste of stevia, does not exhibit the astringent after-taste of stevia, does not exhibit the undesirable smell of stevia, and/or does not exhibit an undesirable smell or undesirable taste of natural ingredients incorporated therein).

Pursuant to one or more embodiments of the stevia supplement described herein, while conventional preservatives may be used (as already noted), it is important to reiterate that health conscious consumers often prefer all-natural products made with ingredients being free of synthetic or semi-synthetic preservatives and other non-natural additives. According to other embodiment(s), the stevia supplement may exclude any one or more of tartaric acid, kola nut extract, caffeine, caramel, erythritol and/or annatto. These and other embodiments) of the stevia supplement may he carbonated or may not be carbonated in beverage or other liquid form.

Thus, one or more embodiments of the stevia supplement described herein may be formed with natural preservatives with 5% acidity, for example (together with the other natural ingredients described herein). Suitable natural preservatives for formulating the natural stevia supplement may include (or at least may include) the following:
(d1) apple cider vinegar (which may be filtered, distilled and/or pasteurized);
(d2) white vinegar (which may be filtered, distilled and/or pasteurized);
(d3) apple cider vinegar (which may be filtered, distilled and/or pasteurized) and citric acid (which may be filtered and/or pasteurized);
(d4) white vinegar (which may be filtered, distilled and/or pasteurized) and citric acid (which may be filtered and/or pasteurized);
(d5) natural vinegar (which may be filtered, distilled and/or pasteurized) and natural citric acid (which may be filtered and/or pasteurized); and
(d6) any combination of the above provided that citric acid is not used without the vinegar.

The vinegar ingredient noted above also may be any natural vinegar and may be any one or more of the following vinegars according to one or more embodiments of the stevia supplement described herein:
(d7) white vinegar (natural);
(d8) apple cider vinegar (natural):
(d9) any natural vinegar; and
(d10) any combination of the above (d1 to d9).

With respect to the amount of vinegar (e.g., white vinegar, apple cider vinegar, natural vinegar or any combination thereof) in the final stevia supplement, the amount of vinegar present may be any one of the following (pursuant to one or more embodiments of the final stevia supplement) based on a final total weight of the final stevia supplement itself:
(dd1) from about 0.05% vinegar to about 10% vinegar;
(dd2) from about 0.1% vinegar to about 9% vinegar;
(dd3) from about 0.2% vinegar to about 8% vinegar;
(dd4) from about 0.25% vinegar to about 7% vinegar;
(dd5) from about 0.3% vinegar to about 6% vinegar;
(dd6) from about 0.4% vinegar to about 5% vinegar;
(dd7) from about 1% vinegar to about 4.9% vinegar;
(dd8) from about 2% vinegar to about 4.8% vinegar;
(dd9) from about 3% vinegar to about 4.7% vinegar;
(dd10) from about 4% vinegar to about 4.6% vinegar;
(dd11) from about 4.2% vinegar to about 5.0% vinegar;
(dd12) from about 0.05% vinegar to about 99% vinegar;
(dd13) from about 0.1% vinegar to about 95% vinegar;
(dd14) from about 0.11% vinegar to about 90% vinegar;
(dd15) from about 0.12% vinegar to about 85% vinegar;
(dd16) from about 0.13% vinegar to about 80% vinegar;
(dd17) from about 0.14% vinegar to about 75% vinegar;
(dd18) from about 0.15% vinegar to about 70% vinegar;
(dd19) from about 0.16% vinegar to about 65% vinegar;
(dd20) from about 0.17% vinegar to about 60% vinegar;
(dd21) from about 0.18% vinegar to about 55% vinegar;
(dd22) from about 0.19% vinegar to about 50% vinegar;
(dd23) from about 0.20% vinegar to about 45% vinegar;
(dd24) from about 0.30% vinegar to about 40% vinegar;
(dd25) from about 0.40% vinegar to about 35% vinegar;
(dd26) from about 0.50% vinegar to about 30% vinegar;
(dd27) from about 0.60% vinegar to about 25% vinegar;
(dd28) from about 0.70% vinegar to about 20% vinegar;
(dd29) from about 0.80% vinegar to about 15% vinegar;
(dd30) from about 0.9% vinegar to about 14% vinegar;
(dd31) from about 1.0% vinegar to about 13% vinegar;
(dd32) from about 1.50% vinegar to about 12% vinegar;
(dd33) from about 2.00% vinegar to about 11% vinegar;
(dd34) from about 2.50% vinegar to about 10% vinegar; and
(dd35) each of the above noted ranges restated with the term “about” deleted in both instances within any given range identified individually under items (dd1) to (dd34).

The optional ingredient (e) of citric acid may be present in combination with the vinegar ingredient (d) and/or a polyene macrolide ingredient (g), such as natamycin noted in more detail below. However when using citric acid as a natural preservative, it is noted that citric acid alone is insufficient to provide the desired preservative effect of the vinegar ingredient (d) and/or polyene macrolide ingredient (g) as further described or illustrated herein.

In effect, the amount of the vinegar ingredient (d) present in the final stevia supplement (in at least one embodiment of the stevia supplement described herein) itself should be sufficient to have the desired preservative effect against the species Staphylococcus Aureus, Pseudomonas Aeruginosa, Escheria Coli, Yeast—Candida Albicans, and Mold—Aspergillus Niger as noted above so as to maintain their respective counts at ≦10 cfu/g at 28 days after exposure to an inoculum of such species. However, if more than 10 cfu/g at 28 days post exposure to an inoculum of the foregoing species is detected (independently for each of the individual species tested), the subject test stevia supplement would still have to pass a USP 24 NF Microbial Limit Test 61, and/or United States Pharmacopeia general (USP) Chapter 51, Antimicrobial Effectiveness Testing, in order to determine that the test stevia supplement was properly preserved to be safe for human ingestion. On the other hand, an indication that the respective species' microbial count is at ≦10 cfu/g at 28 days post exposure to an inoculum or inoculums of the particular above-noted microbial species tested, then such count at ≦10 cfu/g independently for each of the tested microbial species is likely an indication that each of the species tested may be at a level that is not readily detectable or not detected. However, it is desirable that each of the test microbial species be present at least at an acceptable safe level considered suitable for human ingestion (e.g., under USP 24 NF Microbial Limit Test 61, and/or United States Pharmacopeia general (USP) Chapter 51, Antimicrobial Effectiveness Testing).

Also, in one of more embodiments of the stevia supplement described herein, the citric acid ingredient (e) may be added together with the vinegar ingredient (d) and/or a polyene macrolide ingredient (g), such as natamycin noted in more detail below, to provide the desired preservative effect described above with respect to the species Staphylococcus Aureus, Pseudomonas Aeruginosa, Escheria Coli, Yeast—Candida Albicans, and Mold—Aspergillus Niger. Also when combining citric acid with vinegar and/or a polyene macrolide, such as natamycin, the amounts of the ingredients may be adjusted so long as the desired safe preservative effect is maintained.

With respect to the amount of citric acid (e.g., from natural sources—such as oranges, grapefruit, orange peel, pineapple, lemons, limes, etc. used in combination with vinegar and/or a polyene macrolide, such as natamycin) in the final stevia supplement, the amount of citric acid present may be any one of the following amounts (pursuant to one or more embodiments of the final stevia supplement) based on a final total weight of the final stevia supplement itself:
(ee1) from about 0.05% citric acid to about 5% citric acid;
(ee2) from about 0.1% citric acid to about 2.5%) citric acid;
(ee3) from about 0.1% citric acid to about 2% citric acid;
(ee4) from about 0.2 citric acid to about 1% citric acid;
(ee5) from about 0.3% citric acid to about 0.5% citric acid;
(ee6) from about 0.1%) citric acid to about 0.15%) citric acid;
(ee7) from about 0.1% citric acid to about 0.16% citric acid;
(ee8) from about 0.1% citric acid to about 0.17% citric acid;
(ee9) from about 0.1% citric acid to about 0.18% citric acid;
(ee10) from about 0.1% citric acid to about 0.19% citric acid;
(ee11) from about 0.1% citric acid to about 0.2% citric acid; and
(ee12) each of the above noted ranges restated with the term “about” deleted in both instances within any given range identified individually under items (ee1) to (ee11).

Also, in one of more embodiments of the stevia supplement described herein, the polylysine ingredient (f) may be added together with the vinegar ingredient (d) and/or a polyene macrolide ingredient (g), such as natamycin noted in more detail below, to provide the desired preservative effect described above with respect to the species Staphylococcus Aureus, Pseudomonas Aeruginosa, Escheria Coli, Yeast—Candida Albicans, and Mold—Aspergillus Niger. Also when combining polylysine with vinegar and/or polyene macrolide, the amounts of the ingredients may be adjusted so long as the desired safe preservative effect is maintained.

With respect to the amount of polylysine (e.g., may be produced from natural bacterial fermentation processes) in the final stevia supplement, the amount of polylysine present may be any one of the following amounts (pursuant to one or more embodiments of the final stevia supplement) based on a final total weight of the final stevia supplement itself:
(ff1) from about 0.05% polylysine to about 5% polylysine;
(ff2) from about 0.1% polylysine to about 2.5% polylysine;
(ff3) from about 0.1% polylysine to about 2% polylysine;
(ff4) from about 0.2 polylysine to about 1% polylysine;
(ff5) from about 0.3% polyiysine to about 0.5% polyiysine;
(ff6) from about 0.1% polyiysine to about 0.15% polyiysine;
(ff7) from about 0.1% polyiysine to about 0.16% polyiysine;
(ff8) from about 0.1% polyiysine to about 0.17% polyiysine;
(ff9) from about 0.1% polyiysine to about 0.18% polyiysine;
(ff10) from about 0.1% polyiysine to about 0.19% polyiysine;
(ff11) from about 0.1% polyiysine to about 0.2% polyiysine; and
(ff12) each of the above noted ranges restated with the term “about” deleted in both instances within any given range identified individually under items (ff1) to (ff11).

In addition to using a vinegar ingredient as noted above, one or more embodiments of the stevia supplement described herein may be formed with natural preservatives together with one or more of the other natural ingredients described herein. Suitable natural preservatives for formulating the natural stevia supplement may include (or at least may include) the following:
(g1) a polyene macrolide, such as natamycin (a natural material derived from or produced during fermentation);
(g2) a polyene macrolide, such as amphotericin B;
(g3) a polyene macrolide, such as nystatin;
(g4) a polyene macrolide, such as filipin;
(g5) a polyene macrolide, such as natamycin (a natural material derived from or produced during fermentation) and citric acid (which may be filtered and/or pasteurized);
(g6) a polyene macrolide, such as amphotericin B and citric acid (which may be filtered and/or pasteurized);
(g7) a polyene macrolide, such as nystatin and citric acid (which may be filtered and/or pasteurized);
(g8) a polyene macrolide, such as filipin and citric acid (which may be filtered and/or pasteurized);
(g9) any combination of the above provided that citric acid is not used without the polyene macrolide.

The polyene macrolide ingredient noted above also may be any polyene macrolide and may be any one or more of the following polyene macrolide according to one or more embodiments of the stevia supplement described herein:
(g10) natamycin (a natural material derived from or produced during fermentation);
(g11) amphotericin B;
(g12) nystatin;
(g13) filipin; and
(g14) any combination of the above (g1 to g13).

With respect to the amount of polyene macrolide (e.g., natamycin, amphotericin B, nystatin, filipin or any combination thereof) in the final stevia supplement, the amount of polyene macrolide present may be any one of the following (pursuant to one or more embodiments of the final stevia supplement) based on a final total weight of the final stevia supplement itself:
(gg1) from about 0.001% polyene macrolide to about 5% polyene macrolide;
(gg2) from about 0.01% polyene macrolide to about 4% polyene macrolide;
(gg3) from about 0.02% polyene macrolide to about 3% polyene macrolide;
(gg4) from about 0.03% polyene macrolide to about 2% polyene macrolide;
(gg5) from about 0.04% polyene macrolide to about 1% polyene macrolide;
(gg6) from about 0.05% polyene macrolide to about 0.9% polyene macrolide;
(gg7) from about 0.06% polyene macrolide to about 0.8%) polyene macrolide;
(gg8) from about 0.07% polyene macrolide to about 0.7% polyene macrolide;
(gg9) from about 0.08% polyene macrolide to about 0.6% polyene macrolide;
(gg10) from about 0.09% polyene macrolide to about 0.5% polyene macrolide;
(gg11) from about 0.1% polyene macrolide to about 0.4% polyene macrolide;
(gg12) from about 0.15% polyene macrolide to about 0.3%) polyene macrolide;
(gg13) from about 0.16% polyene macrolide to about 0.2% polyene macrolide;
(gg14) from about 0.17% polyene macrolide to about 0.2% polyene macrolide;
(gg15) from about 0.18% polyene macrolide to about 0.2%) polyene macrolide;
(gg16) from about 0.19% polyene macrolide to about 0.2% polyene macrolide; and
(gg17) each of the above noted ranges restated with the term “about” deleted in both instances within any given range identified individually under items (gg1) to (gg16).

The optional ingredient (e) of citric acid may be present in combination with the polyene macrolide ingredient (g). However when using citric acid as a natural preservative, it is noted that citric acid when used alone is insufficient to provide the desired preservative effect of the polyene macrolide ingredient (g).

Further, the optional ingredient (f) of polylysine (which may be produced by bacterial fermentation) may be present in combination with the polyene macrolide ingredient (g). However when polylysine as a natural preservative, it is noted that polylysine alone is insufficient to provide the desired preservative effect of the polyene macrolide ingredient (g).

In effect, the amount of the polyene macrolide ingredient (g) present in the final stevia supplement (in at least one embodiment of the stevia supplement described herein) itself should be sufficient to have the desired preservative effect against the species Staphylococcus Aureus, Pseudomonas Aeruginosa, Escheria Coli, Yeast—Candida Albicans, and Mold—Aspergillus Niger as noted above so as to maintain their respective counts at ≦10 cfu/g at 28 days after exposure to an inoculum of such species. However, if more than 10 cfu/g at 28 days post exposure to an inoculum of the foregoing species is detected (independently for each of the individual species tested), the subject test stevia supplement would still have to pass a USP 24 NF Microbial Limit Test 61, and/or United States Pharmacopeia general (USP) Chapter 51, Antimicrobial Effectiveness Testing, in order to determine that the test stevia supplement was properly preserved to be safe for human ingestion. On the other hand, an indication that the respective species' microbial count is at ≦10 cfu/g at 28 days post exposure to an inoculum or inoculums of the particular above-noted microbial species tested, then such count at ≦10 cfu/g independently for each of the tested microbial species is likely an indication that each of the species tested may be at a level that is not readily detectable or not detected. However, it is desirable that each of the test microbial species be present at least at an acceptable safe level considered suitable for human ingestion (e.g., under USP 24 NF Microbial Limit Test 61 and/or United States Pharmacopeia general (USP) Chapter 51, Antimicrobial Effectiveness Testing).

Also, in one of more embodiments of the stevia supplement described herein, the citric acid ingredient (e) and/or the polylysine ingredient (t) may be added together with the polyene macrolide ingredient (g) to provide the desired preservative effect described above with respect to the species Staphylococcus Aureus, Pseudomonas Aeruginosa, Escheria Coli, Yeast—Candida Albicans, and Mold—Aspergillus Niger. Also when combining citric acid and/or polylysine with polyene macrolide, the amounts of the two may be adjusted so long as the desired safe preservative effect is maintained.

With respect to the amount of citric acid (e.g., from natural sources—such as oranges, grapefruit, orange peel, pineapple, lemons, limes, etc. used in combination with vinegar) in the final stevia supplement, the amount of citric acid present may be any one of the amounts (pursuant to one or more embodiments of the final stevia supplement) listed above based on a final total weight of the final stevia supplement itself.

In the natural stevia supplements prepared according to one or more embodiments of the same described herein, natural forms of stevia, natural forms of vinegar and/or polyene macrolide, natural forms of citric acid (optional), polylysine (optional), and other natural water-soluble ingredients (optional) may be combined in de-ionized water (or distilled water) to form the final natural stevia supplement itself,

Optional water-soluble natural additives (e.g., ingredient (c) above may include natural additives such as vitamins, anti-oxidants, green tea, other teas, glucosamine, or other desirable natural ingredients and/or some combinations) thereof) may be used so long as they do not adversely affect the desired preservative action of the vinegar; polyene macrolide; or the preservative action of the combination of vinegar and natural citric acid; or vinegar, polyene macrolide and citric acid; or polyene macrolide and citric acid; or vinegar and polylysine; or polyene macrolide and polylysine; or vinegar, polyene macrolide, and polylysine. The citric acid may be an extract from citrus, oranges, orange peels, pineapple, grapefruit, any fruit or plant or part thereof containing vitamin C, any peel from any fruit containing vitamin C suitable and safe for human consumption, etc. The vitamins may be any water-soluble essential vitamins that are not vitamin A, not vitamin E or not vitamin D in certain embodiments of the final stevia supplement. The stevia supplement may optionally contain chelating agents (e.g., natural chelators) to chelate calcium ions and zinc ions from the water, the vinegar, the citric acid or other components included or used in the final stevia supplement.

According to one or more embodiments, non-natural ingredients may be excluded from the final stevia supplements) described herein even if such non-natural ingredients may be described in the '835 patent, in the '311 application and/or in the '140 application.

According to one or more embodiments, the natural stevia supplement contains no non-natural ingredients (e.g., contains only ingredients that are obtained from natural sources and the ingredients are not synthetically made). Natural ingredients would be those that do not preclude characterizing the final stevia supplement as “natural,” or as “100% natural,” or as “all natural” or an equivalent description of these three terms.

Of course, water is considered a natural ingredient even in its de-ionized form. Deionized water may be preferred because de-ionization removes undesirable salts and ions therefrom. Likewise, distilled water is also considered a natural ingredient even if distilled. Distilled water may be preferred because distillation also removes undesirable contaminants from the water. The water may also be filtered to maintain its purity suitable for safe use and consumption. The water may also be adequately sterilized either by heat and/or filtration or other suitable method that is suitable for use in the food, beverage, supplement and/or medicinal industries and so long as the water is safe for consumption by humans.

With respect to an embodiment where a non-natural stevia supplement is sought, then non-natural ingredients may be included in the stevia supplement described herein—if so desired.

Nevertheless, where only natural ingredients are to be used, the so-formed final stevia supplement (pursuant to a given embodiment of the same) would be considered (on the whole) a natural stevia supplement. One or more embodiments of such natural stevia supplement should have (i) a desirable taste and flavor profile of sweetness using stevia (to mimic or approximately mimic the taste of natural sugar) together with (ii) a desirable preservative effect, but (iii) should avoid having the undesirable bitter or other undesirable flavor or smell characteristics associated with stevia. Also, the final stevia supplement (as a whole) should have a desirable flavor and smell profile together with the requisite preservative profile (e.g., <10 cfu/g of various microbials as further described herein) pursuant to another embodiment of the same.

To that end, the following non-limiting illustrative examples and certain comparative examples demonstrate the benefits of one or more embodiments of natural stevia supplements described herein that have at least the characteristics (i), (ii) and (iii) indicated above together with the requisite preservative profiles sought.

Unless indicated otherwise herein, all percentage values are percent by weight values based on a total weight of the final stevia supplement.

It should be understood by those of ordinary skill upon reading this application that the embodiments and examples (whether comparative or not) are provided for illustrative purposes only. The examples are not intended to be limiting since the scope of the disclosure will be limited only by the appended claims and equivalents thereof.

### ILLUSTRATIVE EXAMPLES AND COMPARATIVE EXAMPLES

The stock stevia solution may be made with stevia powder obtained from Wisdom Naturals LLC of Gilbert, Ariz. or another raw material supplier of stevia.

The vinegar used may be obtained from the Heinz® company. The particular vinegar used was Heinz® brand (5% acidity) distilled white vinegar that was also pasteurized. Indication of the pasteurization of the Heinz® brand (5% acidity) distilled white vinegar product used was obtained from the Heinz® company's website describing its distilled white vinegar and also describing its distilled apple cider vinegar. Each of these Heinz® brand vinegars are believed to be filtered and pasteurized before being sold by the Heinz® company,

However, the actual vinegar used was the Heinz® brand (5% acidity) distilled white vinegar product.

Pursuant to or in conjunction with the USP 24 NF Microbial Limit Tests 61, and/or United States Pharmacopeia general (USP) Chapter 51, Antimicrobial Effectiveness Testing, the inoculum(s) for the below noted microbial species used were as follows:

| | |
|---|---|
| Staphylococcus Aureus | 480,000 cfu/g; |
| Pseudomonas Aeruginosa | 610,000 cfu/g; |
| Escheria Coli | 240,000 cfu/g; |
| Yeast - Candida Albicans | 350,000 cfu/g; and |
| Mold - Aspergillus Niger | 400,000 cfu/g. |

The foregoing inoculums were used in the Examples and the Comparative Examples as described in further detail herein.

### Microbial Stability of Concentrated Stock Stevia Solution Containing Natural Preservative(s)

### Comparative Example 1

This Comparative Example 1 illustrates that the use of citric acid alone leads to undesirable microbial growth for the yeast and mold species tested at 14 days and at 28 days post exposure. Therefore, the use of citric acid alone is insufficient to properly preserve the stevia supplement formed without vinegar.

Table II below summarizes the composition of the stevia supplement formed as well as the microbial stability results thereof.

TABLE II
Microbial stability Results (w/ Citric Acid Alone)

| | | | Volume or |
|---|---|---|---|
| | | | Size |
| | Comparative Example 1 Ingredient(s) | % by Wt. | 400 ml |
| 1 | Water | 82.3 | 329.2 |
| 2 | Stevia extract 90% (40% Rebaudioside) | 17.5 | 70 |
| 3 | Citric acid | 0.2 | 0.8 |
| | Total | 100 | 400 |
| | | Day 14 | Day 28 |
| | Microbial stability test results | APC (cfu/g) | APC (cfu/g) |
| | Staphylococcus Aureus | <10 | <10 |
| | Pseudomonas Aeruginosa | <10 | <10 |
| | Escherichia Coli | <10 | <10 |
| | Yeast: Candida Albicans | 1,000,000 | Not |
| | | | measured |
| | Mold: Aspergillus Niger | 1,600 | 800,000 |

The above-noted inoculum(s) for the listed microbial species were used in this Comparative Example 1.

Note that APC=Aerobic Plate Count. Note Comparative Example 1 failed the Preservative Effectiveness Test (PET) because the preservative was not effective against the tested yeast and mold species specified. No further microbial growth measurements were made at 28 days post exposure against the yeast species noted in Table II because the formation of mold at 1,600 cfu/g already far exceeded the level necessary for the requisite preservative effect sought (i.e., failed the PET test) using citric acid alone as the preservative. In sum, Comparative Example 1 demonstrates a failed PET result under the USP 24 NF Microbial Limit Test 61, and/or United States Pharmacopeia general (LISP) Chapter 51, Antimicrobial Effectiveness Testing.

As is readily apparent from Table II above, the growth of the yeast species (e.g., Candida Albicans) and the growth of the mold species (e.g., Aspergillus Niger) far exceeded any acceptable upper limit microbial growth for the so-formed stevia supplement necessary to qualify the supplement as properly preserved at 14 days post exposure (for the yeast) and both at 14 days and at 28 days post exposure (for the mold). Certainly exhibiting early excessive microbial growth at 14 days post exposure (1,000,000 cfu/g for the yeast and 1,600 cfu/g for the mold) to the inoculum(s) also means failing the USP 24 NF Microbial Limit Test 61, and/or United States Pharmacopeia general (USP) Chapter 51, Antimicrobial Effectiveness Testing, at 28 days post exposure to the inoculum(s) because the early failure at 14 days rules out a different outcome at 28 days post exposure to the inoculum(s).

### Comparative Example 1a

This Comparative Example 1a, like Comparative Example 1, also illustrates that citric acid alone is insufficient to provide the requisite preservative effect sought for the tested stevia supplement as illustrated in Table IIa below:

TABLE IIa
Microbial Stability Results (w/Citric Acid Alone)

| | | | Volume or |
|---|---|---|---|
| | Comparative Example 1a | | Size |
| | Ingredient(s) | % by Wt. | 400 ml |
| 1 | Water | 82 | 328 |
| 2 | Stevia extract 90% (40% Rebaudioside) | 17.5 | 70 |
| 3 | Citric acid | 0.5 | 2 |
| | Total | 100 | 400 |
| | | Day 14 | Day 28 |
| | Microbial stability test results | APC (cfu/g) | APC (cfu/g) |
| | Staphylococcus Aureus | <10 | <10 |
| | Pseudomonas Aeruginosa | <10 | <10 |
| | Escherichia Coli | <10 | <10 |
| | Yeast: Candida Albicans | 1,300,000 | Not |
| | | | measured |
| | Mold: Aspergillus Niger | 600 | 100,000 |

The inoculum load was the same as that of Comparative Example 1.

APC=Aerobic Plate Count; cfu/g=coliform units per gram,

PET Result=Failed as the microbial species—Yeast: Candida Albicans and Mold: Aspergillus Niger—each exceeded the acceptable limits of microbial growth at day 14 post exposure for the listed yeast and mold species even though for the species Staphylococcus Aureus, Pseudomonas Aeruginosa, and Escherichia Coli the cfu/g remained below 10 cfu/g at day 14 and at day 28 post exposure to the inoculums's).

### Example 1

By comparison, Example 1 below illustrates that combining vinegar with citric acid for nearly the same formulation as that of Table II yields a final stevia supplement that is properly preserved. The formulation of Table II combines Heinz brand® natural distilled white vinegar with citric acid (natural). See Table III below indicating the same:

TABLE III
Microbial Stability Results (w/Vinegar and Citric Acid Combined)

| | | | Volume or |
|---|---|---|---|
| | | | Size |
| | Example 1 Ingredient(s) | % by Wt. | 400 ml |
| 1 | Water | 77.3 | 309.2 |
| 2 | Stevia extract 90% (40% Rebaudioside) | 17.5 | 70 |
| 3 | Citric Acid | 0.2 | 0.8 |
| 4 | Vinegar | 5 | 20 |
| | Total | 100 | 400 |
| | | Day 14 | Day 28 |
| | Microbial stability test results | APC (cfu/g) | APC (cfu/g) |
| | Staphylococcus Aureus | <10 | <10 |
| | Pseudomonas Aeruginosa | <10 | <10 |
| | Escherichia Coli | <10 | <10 |
| | Yeast: Candida Albicans | <10 | <10 |
| | Mold: Aspergillus Niger | <10 | <10 |

The inoculum load was the same as that of Comparative Example 1.

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger.

### Comparative Example 2

Comparative Example 2 illustrates that use of non-natural and/or synthetic preservatives provides a stevia supplement that is properly preserved as noted in Table IV below:

TABLE IV
Microbial Stability Results
(w/Non-Natural and/or Synthetic Preservative Sorbic Acid)

| | | | Sample | | Sample | | Sample |
|---|---|---|---|---|---|---|---|
| | | | A | | B | | C |
| | | | Vol- | | Vol- | | Vol- |
| | Comparative | % | ume | % | ume | % | ume |
| | Example 2 | by | or Size | by | or Size | by | or Size |
| | Ingredient(s) | Wt. | 400 ml | Wt. | 400 ml | Wt. | 400 ml |
| 1 | Water | 82.1 | 328.4 | 82.4 | 329.6 | 67.1 | 268.4 |
| 2 | Stevia extract | 17.5 | 70 | 17.5 | 70 | 17.5 | 70 |
| | 40% | | | | | | |
| | Rebaudioside | | | | | | |
| 3 | Grapefruit | 0.3 | 1.2 | 0 | 0 | 03 | 1.2 |
| | juice | | | | | | |
| | Extract 40x | | | | | | |
| 4 | Vegetable | 0.1 | 0 | 0 | 0 | 15 | 60 |
| | Glycerin | | | | | | |
| | Sorbic acid | 0.1 | 0.4 | 0.1 | 0.4 | 0.1 | 0.4 |
| | | 0 | 0 | 0 | 0 | 0 | 0 |
| | Total | 100 | 400 | 100 | 400 | 100 | 400 |
| | | Day | Day | Day | Day | Day | Day |
| | Microbial | 14 | 28 | 14 | 28 | 14 | 28 |
| | stability test | APC | APC | APC | APC | APC | APC |
| | results | (cfu/g) | (cfu/g) | (cfu/g) | (cfu/g) | (cfu/g) | (cfu/g) |
| | Staph- | <10 | <10 | <10 | <10 | <10 | <10 |
| | ylococcus | | | | | | |
| | Aureus | | | | | | |
| | Pseudomonas | <10 | <10 | <10 | <10 | <10 | <10 |
| | Aeraginosa | | | | | | |
| | Escherichia | <10 | <10 | <10 | <10 | <10 | <10 |
| | Coil | | | | | | |
| | Yeast: | <10 | <10 | <10 | <10 | <10 | <10 |
| | Candida | | | | | | |
| | Albicans | | | | | | |
| | Mold: | <10 | <10 | <10 | <10 | <10 | <10 |
| | Aspergillus | | | | | | |
| | Niger | | | | | | |

The inoculum load was the same as that of Comparative Example 1.

APC=Aerobic Plate Count; cfu/g=coliform units per gram.

PET Result=Passed as each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

Note that sorbic acid served as non-natural preservative in Comparative Example 2. Thus, the formulations of Table IV are not considered “natural” stevia supplements.

### Example 2

Example 2 illustrates that the natural preservative (vinegar alone) preserves the stevia supplement as well as does the non-natural preservative (sorbic acid). See Table V below.

TABLE V
Microbial Stability Results (w/ Vinegar Alone)

| | | | Size or Volume |
|---|---|---|---|
| | Example 2 Ingredient(s) | % by Wt. | 400 ml |
| 1 | Water | 72.5 | 290 |
| 2 | Stevia extract 90% (40% Rebaudioside) | 17.5 | 70 |
| 3 | Vinegar | 10 | 40 |
| | Total | 100 | 400 |

| | Day 14 | Day 28 |
|---|---|---|
| Microbial stability test results | APC (cfu/g) | APC (cfu/g) |
| Staphylococcus Aureus | <10 | <10 |
| Pseudomonas Aeruginosa | <10 | <10 |
| Escherichia Coli | <10 | <10 |
| Yeast: Candida Albicans | <10 | <10 |
| Mold: Aspergillus Niger | <10 | <10 |

The inoculum load was the same as that of Comparative Example 1.

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger.

Also, when Example 1 is compared to compared to Comparative Example 2, it is also clear that the combined preservative action of vinegar plus citric acid also preserves the stevia supplement just as well as does the non-natural sorbic acid preservative because the PET Result=Passed for Example 1 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

Referring now to the test results identified in Example 3 through Example 8, which follow, the PET for each example was performed pursuant to or in conjunction with United States Pharmacopeia general (USP) Chapter 51, Antimicrobial Effectiveness Testing, and the inoculum(s) used for the tests are noted below in each Table shown in each Example and used the following microbial species: Staphylococcus Aureus; Pseudomonas Aeruginosa; Escheria Coli; Yeast—Candida Albicans; and Mold—Aspergillus Niger. The inoculums used in Example 3 through Example 8 are described in further detail herein below. It will be appreciated that when the PET is combined with shelf life stability noted herein below, it is used to determine expiration dating.

### Example 3

In Example 3, the PET was done according to United States Pharmacopeia general (USP) Chapter 51, Antimicrobial Effectiveness Testing, Example 3 illustrates that the natural preservative (vinegar used in combination with citric acid) preserves the stevia supplement as well as does the non-natural preservative (sorbic acid) and demonstrates that the preservative stops the growth of pathogenic organisms and therefore protects the composition from microbial contamination. See Table VI below.

TABLE VI
Microbial Stability Results (w/ Vinegar and Citric Acid)

| Ingredient | % by Wt. |
|---|---|
| DI water | 77.3 |
| Citric Acid | 0.2 |
| Vinegar | 5 |
| Stevia Extract 90% rebaudioside | 17.5 |
| Total | 100 |

| | Initial | Day 14 | Day 28 |
|---|---|---|---|
| Microbial stability test results | Inoculum/g | APC (cfu/g) | APC (cfu/g) |
| APC: Staphylococcus Aureus | 4.8 × 10E5 | <10E2 | <10E2 |
| APC: Pseudomonas | 6.1 × 10E5 | <10E2 | <10E2 |
| Aeruginosa | | | |
| APC: Escherichia Coli | 2.4 × 10E5 | <10E2 | <10E2 |
| Yeast: Candida Albicans | 2.5 × 10E5 | <10E2 | <10E2 |
| Mold: Aspergillus Niger | 4.0 × 10E5 | <10E2 | <10E2 |

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger. Also, when Example 3 is compared to compared to Comparative Example 2, it is also clear that the combined preservative action of vinegar plus citric acid also preserves the stevia supplement just as well as does the non-natural sorbic acid preservative because the PET Result=Passed for Example 3 where each microbial species measured below 10 cfu/g at day 14 and at day 28 post exposure to the inoculum(s) of Staphylococcus Aureus. Pseudomonas Aeruginosa, Escherichia Coli, Yeast: Candida Albicans, and Mold: Aspergillus Niger.

### Example 4

In Example 4, the PET was done according to United States Pharmacopeia general (USP) Chapter 51, Antimicrobial Effectiveness Testing. Example 4 illustrates that the natural preservative (vinegar, natamycin used in combination with citric acid) preserves the stevia supplement as well as does the non-natural preservative (sorbic acid) and demonstrates that the preservative stops the growth of pathogenic organisms and therefore protects the composition from microbial contamination. See Table VII below.

TABLE VII
Microbial Stability Results (w/ Vinegar, Natamycin and Citric Acid)

| Ingredient | % by Wt. |
|---|---|
| DI water | 77.25 |
| Natamycin | 0.05 |
| Citric Acid | 0.2 |
| Vinegar | 5 |
| Stevia Extract 90% rebaudioside | 17.5 |
| Total | 100 |

| | | | Day 28 |
|---|---|---|---|
| | Initial | Day 14 | APC |
| Microbial stability test results | Inoculum/g | APC (cfu/g) | (cfu/g) |
| APC: Staphylococcus Aureus | 7.0 × 10E6 | <10E2 | <10E2 |
| APC: Pseudomonas | 4.9 × 10E7 | <10E2 | <10E2 |
| Aeruginosa | | | |
| APC: Escherichia Coli | 2.65 × 10E7 | <10E2 | <10E2 |
| Yeast: Candida Albicans | 4.0 × 10E6 | <10E2 | <10E2 |
| Mold: Aspergillus Niger | 6.5 × 10E5 | <10E2 | <10E2 |

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger. Also, when Example 4 is compared to compared to Comparative Example 2, if is also clear that the combined preservative action of vinegar, plus natamycin, plus citric acid also preserves the stevia supplement just as well as does the non-natural sorbic acid preservative because the PET Result=Passed for Example 4 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

### Example 5

In Example 5, the PET was done according to United States Pharmacopeia general (USP) Chapter 51, Antimicrobial Effectiveness Testing. Example 5 illustrates that the natural preservative (natamycin used in combination with vinegar) preserves the stevia supplement as well as does the non-natural preservative (sorbic acid) and demonstrates that the preservative stops the growth of pathogenic organisms and therefore protects the composition from microbial contamination. See Table VIII below.

TABLE VIII
Microbial Stability Results (w/Natamycin and Vinegar)

| Ingredient | % by Wt. |
|---|---|
| DI water | 77.4 |
| Natamycin | 0.1 |
| Vinegar | 5 |
| Stevia Extract 90% rebaudioside | 17.5 |
| Total | 100 |

| | | | Day 28 |
|---|---|---|---|
| | Initial | Day 14 | APC |
| Microbial stability test results | Inoculum/g | APC (cfu/g) | (cfu/g) |
| APC: Staphylococcus Aureus | 7.0 × 10E6 | <10E2 | <10E2 |
| APC: Pseudomonas Aeruginosa | 4.9 × 10E7 | <10E2 | <10E2 |
| APC: Escherichia Coli | 2.65 × 10E7 | <10E2 | <10E2 |
| Yeast: Candida Albicans | 4.0 × 10E6 | <10E2 | <10E2 |
| Mold: Aspergillus Niger | 6.5 × 10E5 | <10E2 | <10E2 |

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger. Also, when Example 5 is compared to compared to Comparative Example 2, it is also clear that the combined preservative action of natamycin plus vinegar also preserves the stevia supplement just as well as does the non-natural sorbic acid preservative because the PET Result=Passed for Example 5 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

### Example 6

In Example 6, the PET was done according to United States Pharmacopeia general (USP) Chapter 51, Antimicrobial Effectiveness Testing. Example 6 illustrates that the natural preservative (natamycin used in combination with citric acid) preserves the stevia supplement as well as does the non-natural preservative (sorbic acid) and demonstrates that the preservative stops the growth of pathogenic organisms and therefore protects the composition from microbial contamination. See Table IX below.

TABLE IX
Microbial Stability Results (w/Natamycin and Citric Acid)

| Ingredient | % by Wt. |
|---|---|
| DI water | 82.2 |
| Natamycin | 0.1 |
| Citric Acid | 0.2 |
| Stevia Extract 90% rebaudioside | 17.5 |
| Total | 100 |

| | | | Day 28 |
|---|---|---|---|
| | Initial | Day 14 | APC |
| Microbial stability test results | Inoculum/g | APC (cfu/g) | (cfu/g) |
| APC: Staphylococcus Aureus | 7.0 × 10E6 | <10E2 | <10E2 |
| APC: Pseudomonas Aeruginosa | 4.9 × 10E7 | <10E2 | <10E2 |
| APC: Escherichia Coli | 2.65 × 10E7 | <10E2 | <10E2 |
| Yeast: Candida Albicans | 4.0 × 10E6 | <10E2 | <10E2 |
| Mold: Aspergillus Niger | 6.5 × 10E5 | <10E2 | <10E2 |

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger. Also, when Example 6 is compared to compared to Comparative Example 2, it is also clear that the combined preservative action of natamycin plus citric acid also preserves the stevia supplement just as well as does the non-natural sorbic acid preservative because the PET Result=Passed for Example 6 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

### Example 7

In Example 7, the PET was done according to United States Pharmacopeia general (USP) Chapter 51, Antimicrobial Effectiveness Testing. Example 7 illustrates that the natural preservative (natamycin used in combination with polylysine) preserves the stevia supplement as well as does the non-natural preservative (sorbic acid) and demonstrates that the preservative stops the growth of pathogenic organisms and therefore protects the composition from microbial contamination, See Table X below.

TABLE X
Microbial Stability Results (w/Natamycin and Polylysine)

| Ingredient | % by Wt. |
|---|---|
| DI water | 82.2 |
| Natamycin | 0.1 |
| Polylysine 25% | 0.2 |
| Stevia Extract 90% rebaudioside | 17.5 |
| Total | 100 |

| | | | Day 28 |
|---|---|---|---|
| | Initial | Day 14 | APC |
| Microbial stability test results | Inoculum/g | APC (cfu/g) | (cfu/g) |
| APC: Staphylococcus Aureus | 7.0 × 10E6 | <10E2 | <10E2 |
| APC: Pseudomonas Aeruginosa | 4.9 × 10E7 | <10E2 | <10E2 |
| APC: Escherichia Coli | 2.65 × 10E7 | <10E2 | <10E2 |
| Yeast: Candida Albicans | 4.0 × 10E6 | <10E2 | <10E2 |
| Mold: Aspergillus Niger | 6.5 × 10E5 | <10E2 | <10E2 |

APC=Aerobic Plate Count; cfu/g=coliform units per gram

PET Result=Passed as each microbial species measured below 10 cfu/g at day 14 and at day 28 post exposure to the inoculum of Staphylococcus Aureus, Pseudomonas Aeruginosa, Escherichia Coli, Yeast: Candida Albicans, and Mold: Aspergillus Niger. Also, when Example 7 is compared to compared to Comparative Example 2, it is also clear that the combined preservative action of natamycin plus polylysine also preserves the stevia supplement just as well as does the non-natural sorbic acid preservative because the PET Result=Passed for Example 7 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

### Example 8

In Example 8, the PET was done according to United States Pharmacopeia general (USP) Chapter 51, Antimicrobial Effectiveness Testing, Example 8 illustrates that the natural preservative (natamycin) preserves the stevia supplement as well as does the non-natural preservative (sorbic acid) and demonstrates that the preservative stops the growth of pathogenic organisms and therefore protects the composition from microbial contamination. See Table XI below.

TABLE XI
Microbial Stability Results (w/Natamycin)

| Ingredient | % by Wt. |
|---|---|
| DI water | 62.45 |
| Natamycin | 0.05 |
| Glycerin | 20 |
| Stevia Extract 90% Rebaudioside | 17.5 |
| Total | 100 |

| | | | Day 28 |
|---|---|---|---|
| | Initial | Day 14 | APC |
| Microbial stability test results | Inoculum/g | APC (cfu/g) | (cfu/g) |
| APC: Staphylococcus Aureus | 7.0 × 10E6 | <10E2 | <10E2 |
| APC: Pseudomonas Aeruginosa | 4.9 × 10E7 | <10E2 | <10E2 |
| APC: Escherichia Coli | 2.65 × 10E7 | <10E2 | <10E2 |
| Yeast: Candida Albicans | 4.0 × 10E6 | <10E2 | <10E2 |
| Mold: Aspergillus Niger | 6.5 × 10E5 | <10E2 | <10E2 |

APC=Aerobic Plate Count: cfu/g=coliform units per gram

PET Result=Passed as each microbial species measured below 10 cfu/g at day 14 and at day 28 post exposure to the inoculum of Staphylococcus Aureus, Pseudomonas Aeruginosa. Escherichia Coli, Yeast: Candida Albicans, and Mold: Aspergillus Niger. Also, when Example 8 is compared to compared to Comparative Example 2, it is also clear that the preservative action of natamycin also preserves the stevia supplement just as well as does the non-natural sorbic acid preservative because the PET Result=Passed for Example 8 where each microbial species measured below 10 cfu/g at day 14 and at day 28 post exposure to the inoculum(s) of Staphylococcus Aureus, Pseudomonas Aeruginosa, Escherichia Coli, Yeast: Candida Albicans, and Mold: Aspergillus Niger.

It will be appreciated that a preservative is effective if two conditions are met: (i) the reduction in microbes is equal or greater than 1.0 log reduction from the initial count (at day 14) and no increase from the initial day 14 count to the day 28 count is observed in the bacteria samples; and (ii) there is no observable increase from the initial calculated count at day 14 to the count at day 28 in the yeast and mold samples. A no-increase means not more than 0.5 log 10 units higher than previously measured. Thus, in Examples 3 through 8, it can be seen that the above test results conform to current USP criteria for the Preservative Effectiveness Test (PET) and therefore the preservation of stevia solutions using the natural materials specified in the above examples is demonstrated. It also demonstrated that stevia solutions can be adequately preserved using either a combination of materials or by using individual materials. Therefore, vinegar or natamycin individually can and may preserve stevia solutions, or vinegar and/or natamycin can and may preserve stevia solutions in combination with citric acid and polylysine.

These results combined with shelf life stability demonstrate that the concentrated stevia solutions have an expiration dating of at least 2 years.

Shelf life is the length of time that a consumer product maintains its defined desirable qualities. It is determined under conditions of normal storage and handling. Shelf life stability when combined with microbial stability (Preservative Effectiveness Test) provides the information required for determination of expiration dating.

### Shelf Life Stability of Concentrated Stevia Solution Preserved with Natural Preservatives

Shelf life may be determined experimentally in a laboratory chamber that is maintained at about 25° C. (77° F.) and 60 RH (relative humidity). These conditions have been used and determined to more closely duplicate the conditions of storage and display of goods in retail stores, such as health food stores, supermarkets and grocery stores.

The following material was stored at 25° C. (77° F.) in a laboratory shelf where humidity was not controlled. Although the humidity condition was not controlled, the material maintained its original desirable qualities two years after it was made. This observation combined with the microbial stability tests identified above in Examples 3 through 8, which were performed under standard conditions to confirm safety, establishes that the material has a minimum shelf life of 2 years.

### Example 9

Concentrated Stevia solution was made according to Table XII below. The specifications of the composition are given in Table XIII below. The characteristics were determined and recorded in Table XIV at the following time intervals: 0 month, 12 months, and 24 months and compared with the specifications given in Table XIII.

TABLE XII
Composition of concentrated Stevia solution preserved naturally.

| Ingredient | % by Wt. |
|---|---|
| Water | 77.3 |
| Stevia extract 90% (40% Rebaudioside) | 17.5 |
| Citric acid | 0.2 |
| vinegar | 5 |
| Total | 100 |

TABLE XIII
Specifications of concentrated Stevia solution preserved naturally.

| CHARACTERISTIC | SPECIFICATION | METHOD |
|---|---|---|
| Color | Straw | Visual |
| Odor | Characteristic | Smell |
| Texture | Liquid | Visual |
| pH | 2-4 | pH Meter |

TABLE XIV
Variation of quality characteristics of concentrated Stevia solution
with time at 25° C. (77° F.)

| Characteristic | 0 month | 12 months | 24 months |
|---|---|---|---|
| Color | Straw colored | Straw colored | Straw colored |
| | liquid | liquid | liquid |
| Odor | Slight sour smell. | Slight sour smell. | Slight sour smell. |
| | Not strong | Not strong or | Not strong or |
| | or offensive. | offensive. Smell | offensive. Smell |
| | Smell of Stevia | of Stevia not | of Stevia not |
| | not detectible | detectible | detectible |
| pH | 2.8 | 2.76 | 2.80 |

The results in Table XIV demonstrate that the concentrated Stevia solution maintained its desirable characteristics (qualities) throughout the 24 months of storage in a laboratory shelf. There was no change in pH or odor and the color remained intact throughout the period of observation. Thus, concentrated Stevia solution made according to Table XII maintains its desirable qualities for at least 24 months (2 years) and therefore has a minimum shelf life of 2 years. This information combined with the successful Preservative Effective Test (PET) illustrated in Examples 3 through 8 provides an expiration dating of 2 years.

### Comparative Differences in Smell and Odor Profiles When Using Vinegar Versus Acetic Acid

### Example 10

The effect of the use of vinegar versus acetic acid on the smell and odor profiles of the stevia stock solution of Table I was evaluated.

Vinegar or acetic acid was added to concentrated stock stevia solution (Table I) of equivalent acid strength to make various sets of test solutions (Table XV, A-H). Panels of five adult persons were each asked to sniff 20 ml of each set and compare the smell and odor of each solution and grade each as acceptable or unacceptable for consumption. The responses are recorded in Table XV below.

Sources of materials used were:
(1) Vinegar: Heinz® brand distilled white vinegar (5% acidify) available from Fry's supermarket.
(2) Acetic Acid: commercial glacial acetic acid bought from Spectrum Chemicals.
(3) Stevia Powder: Stevia extract powder with 90% stevia (40% rebaudioside) obtained from Wisdom Naturals LLC, Gilbert, Ariz.—used to make the stock stevia solution of Table I described herein.

As indicated, Example 10 compares the effect on the odor and/or the smell profiles of stock stevia solution when sought to be preserved with acetic acid instead of vinegar as illustrated in Table XV below:

TABLE XV
Comparative Differences in Smell and Odor (w/ Vinegar versus
Acetic Acid)

| | Concentration | |
|---|---|---|
| Test | (% by Wt.) - in the Stock | |
| Entry | Stevia Solution (Table I) | Smell and Odor Profile Description |
| A | 0.5% Acetic Acid | Strong sour smell that burns your nose. |
| | | Offensive and not tolerable. |
| B | 10% Vinegar (0.5% acid | Sour smell. Not strong or offensive. |
| | equivalent) | Smell of stevia not detectible. |
| C | 0.25% Acetic Acid | Sweet smell like that of stevia. |
| D | 5% Vinegar (0.25% acid | Slight sour smell. Not strong or |
| | equivalent) | offensive. Smell of stevia not |
| | | detectible. |
| E | 0.1% Acetic Acid | Sweet smell like that of stevia. |
| F | Plain Stock Stevia | Sweet smell like that of stevia. |
| | Solution (Table 1) | |
| G | 0.05% Acetic Acid | Still has sweet smell of stevia. |
| H | 0.05% Vinegar | Odorless. |

Whereas vinegar adequately masked the smell of plain stock stevia solution (Table I), acetic acid did not do so per the results of Table XV above. Instead, use of an equivalent amount of acetic acid undesirably enhanced the smell of stevia and the resultant odor was hard to mask. At the equivalent acid strength of acetic acid (as that of 5% acidity of vinegar), acetic acid also burned the nostrils when sniffed. These findings were important because they indicated that vinegar has intrinsic flavor and/or smell controlling properties that cannot be duplicated with acetic acid substitution. Accordingly, the use of acetic acid cannot be deemed to be an equivalent substitution for vinegar based on the results of Table XV above.

In the foregoing Detailed Description, various features of the disclosure are either grouped together in a single embodiment for the purpose of streamlining the disclosure or are discussed in different embodiments. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment and various inventive features disclosed in separate embodiments may be combined to form its own embodiment as claimed more fully below. Thus, the following claims are hereby incorporated into this Detailed Description by this reference, with each claim standing on its own as a separate embodiment of the disclosure. It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in ingredients, size, materials, shape, form, function and manner of operation, assembly and use may be made without departing from the principles and concepts set forth herein.

1. An improved stevia supplement composition comprising:
stevia;
water; and
an effective amount of a polyene macrolide selected from the group consisting of natamycin, amphotericin B, nystatin, and filipin.

2. The composition of claim 1, wherein the stevia supplement composition has a minimum shelf life of at least 2 years.

3. The composition of claim 1, wherein the polyene macrolide selected from the group consisting of natamycin, amphotericin B, nystatin, and filipin provides a preservative action against each of microbial species Staphylococcus Aureus, Pseudomonas Aeruginosa, Escherichia Coli, Yeast: Candida Albicans, and Mold: Aspergillus Niger so that a level of each of these microbial species individually is below an acceptable safe level for human consumption when measured according to United States Pharmacopeia general (USP) Chapter 51, Antimicrobial Effectiveness Testing, at 28 days post exposure to these microbial species occurring via inoculum(s) of

| | | |
|---|---|---|
| Staphylococcus Aureus | 7,000,000 | cfu/g; |
| Pseudomonas Aeruginosa | 49,000,000 | cfu/g; |
| Escheria Coli | 26,500,000 | cfu/g; |
| Yeast - Candida Albicans | 4,000,000 | cfu/g; and |
| Mold - Aspergillus Niger | 650,000 | cfu/g |

applied in accordance with procedures United States Pharmacopeia general (USP) Chapter 51, Antimicrobial Effectiveness Testing for naturally preserving the stevia supplement composition.

4. The composition of claim 1, wherein the composition further comprises an effective amount of vinegar.

5. The composition of claim 4, wherein vinegar is present in an amount to provide a preservative action against each of microbial species Staphylococcus Aureus, Pseudomonas Aeruginosa, Escherichia Coli, Yeast: Candida Albicans, and Mold: Aspergillus Niger so that a level of each of these microbial species individually is below an acceptable safe level for human consumption when measured according to United States Pharmacopeia general (USP) Chapter 51, Antimicrobial Effectiveness Testing, at 28 days post exposure to these microbial species occurring via inoculum(s) of

| | | |
|---|---|---|
| Staphylococcus Aureus | 7,000,000 | cfu/g; |
| Pseudomonas Aeruginosa | 49,000,000 | cfu/g; |
| Escheria Coli | 26,500,000 | cfu/g; |
| Yeast - Candida Albicans | 4,000,000 | cfu/g; and |
| Mold - Aspergillus Niger | 650,000 | cfu/g |

applied in accordance with procedures United States Pharmacopeia general (USP) Chapter 51, Antimicrobial Effectiveness Testing; and
wherein the composition further comprises, optionally, water-soluble natural additive(s) selected from the group consisting of vitamins, anti-oxidants, teas, green tea, glucosamine and combinations thereof, and citric acid.

6. The composition of claim 1, wherein the composition is provided in a liquid form.

7. The composition of claim 1, wherein the stevia is provided in an amount from about 15% to about 20% by weight of stevia based on a total weight of the composition.

8. The composition of claim 4, wherein the vinegar is provided in an amount from about 0.05% to about 10% by weight vinegar based on the total weight of the composition.

9. The composition of claim 8, wherein the vinegar is provided in an amount from about 2.5% to about 10% vinegar based on the total weight of the composition.

10. The composition of claim 8, wherein the composition comprises from about 0.1% to about 0.2% citric acid based on the total weight of the composition.

11. The composition of claim 10, wherein the composition is odorless in comparison to a composition containing an equivalent amount of acetic acid in place of the vinegar.

12. The composition of claim 10, wherein the smell of stevia is not detectable.

13. The composition of claim 4, wherein the preservative action of vinegar is at least equivalent to a preservative action of an equivalent acidic amount of sorbic acid against each of the microbial species Staphylococcus Aureus, Pseudomonas Aeruginosa, Escherichia Coli, Yeast: Candida Albicans, and Mold: Aspergillus Niger when measured according to the United States Pharmacopeia general (USP) Chapter 51, Antimicrobial Effectiveness Testing at 28 days post exposure to the inoculum(s) of the microbial species.

14. The composition of claim 13, wherein the preservative action of the vinegar is sufficient to result in a measured cfu/g level for each of the microbial species Staphylococcus Aureus, Pseudomonas Aeruginosa, Escherichia Coli, Yeast: Candida Albicans, and Mold: Aspergillus Niger to ≦10 cfu/g, to ≦9 cfu/g, to ≦8 cfu/g, to ≦7 cfu/g or lower at 14 days post exposure to the inoculum(s) of the microbial species when measured according to the United States Pharmacopeia general (USP) Chapter 51, Antimicrobial Effectiveness Testing.

15. The composition of claim 14, wherein the preservative action of the vinegar is sufficient to result in the measured cfu/g level for each of the microbial species Staphylococcus Aureus, Pseudomonas Aeruginosa, Escherichia Coli, Yeast: Candida Albicans, and Mold: Aspergillus Niger to ≦6 cfu/g, to ≦5 cfu/g, to ≦4 cfu/g, to ≦3 cfu/g or lower at 28 days post exposure to the inoculum(s) of the microbial species when measured according to the United States Pharmacopeia general (USP) Chapter 51, Antimicrobial Effectiveness Testing.

16. The composition of claim 10, wherein the vinegar and the citric acid together provide a preservative action to result in a measured cfu/g level for each of the microbial species Staphylococcus Aureus, Pseudomonas Aeruginosa, Escherichia Coli, Yeast: Candida Albicans, and Mold: Aspergillus Niger to ≦10 cfu/g, to ≦9 cfu/g, to ≦8 cfu/g, to ≦7 cfu/g or lower at 14 days post exposure to the inoculum(s) of the microbial species when measured according to the United States Pharmacopeia general (USP) Chapter 51, Antimicrobial Effectiveness Testing.

17. The composition of claim 16, wherein the vinegar and the citric acid together provide the preservative action to result in the measured cfu/g level for each of the microbial species Staphylococcus Aureus, Pseudomonas Aeruginosa, Escherichia Coli, Yeast: Candida Albicans, and Mold: Aspergillus Niger to ≦6 cfu/g, to ≦5 cfu/g, to ≦4 cfu/g, to ≦3 cfu/g or lower at 28 days post exposure to the inoculum(s) of the microbial species when measured according to the United States Pharmacopeia general (USP) Chapter 51, Antimicrobial Effectiveness Testing.

18. The composition of claim 1, further comprising any water-soluble vitamin selected from vitamins other than vitamin D, vitamin E, and vitamin A.

19. The composition of claim 1, further comprising vitamin C.

20. The composition of claim 1, further comprising an anti-oxidant that is water soluble.

21. The composition of claim 1, further comprising a water-soluble tea.

22. The composition of claim 21, wherein the tea is green tea.

23. The composition of claim 1, wherein the composition further comprises citric acid, wherein the citric acid is an extract from citrus, grapefruit, pineapple, lemons, limes, or any part of any fruit or plant that contains vitamin C suitable for safe human ingestion.

24. The composition of claim 1, wherein the water is de-ionized water or distilled water and further comprises a chelating agent to chelate Ca ions or Zn ions or both.

25. The composition of claim 1, wherein the composition is free of synthetic ingredients.

26. The composition of claim 24, wherein the composition is free of synthetic ingredients.

27. The composition of claim 1, further comprising glucosamine.

28. The composition of claim 1, excluding synthetic preservatives.

29. The composition of claim 1, excluding tartaric acid.

30. The composition of claim 1, wherein the polyene macrolide is natamycin; and wherein natamycin is provided in an amount from about 0.01% to about 4% by weight based on the total weight of the composition.

31. The composition of claim 30, wherein the composition further comprises an effective amount of vinegar, wherein the preservative action of natamycin and vinegar combination is at least equivalent to a preservative action of an equivalent acidic amount of sorbic acid against each of the microbial species Staphylococcus Aureus, Pseudomonas Aeruginosa, Escherichia Coli, Yeast: Candida Albicans, and Mold: Aspergillus Niger when measured according to the United States Pharmacopeia general (USP) Chapter 51, Antimicrobial Effectiveness Testing at 28 days post exposure to the inoculum(s) of the microbial species.

32. The composition of claim 31, wherein the preservative action of the natamycin and vinegar combination is sufficient to result in a measured cfu/g level for each of the microbial species Staphylococcus Aureus, Pseudomonas Aeruginosa, Escherichia Coli, Yeast: Candida Albicans, and Mold: Aspergillus Niger to ≦10 cfu/g, to ≦9 cfu/g, to ≦8 cfu/g, to ≦7 cfu/g or lower at 14 days post exposure to the inoculum(s) of the microbial species when measured according to the United States Pharmacopeia general (USP) Chapter 51, Antimicrobial Effectiveness Testing.

33. The composition of claim 32, wherein the preservative action of the natamycin and vinegar combination is sufficient to result in the measured cfu/g level for each of the microbial species Staphylococcus Aureus, Pseudomonas Aeruginosa, Escherichia Coli, Yeast: Candida Albicans, and Mold: Aspergillus Niger to ≦6 cfu/g, to ≦5 cfu/g, to ≦4 cfu/g, to ≦3 cfu/g or lower at 28 days post exposure to the inoculum(s) of the microbial species when measured according to the United States Pharmacopeia general (USP) Chapter 51, Antimicrobial Effectiveness Testing.

34. An improved stevia supplement composition comprising:
stevia;
water;
an effective amount of vinegar; and
an effective amount of a polyene macrolide selected from the group consisting of natamycin, amphotericin B, nystatin, and filipin.

35. The composition of claim 34, wherein the effective amount of vinegar provides a preservative action against each of microbial species Staphylococcus Aureus, Pseudomonas Aeruginosa, Escherichia Coli, Yeast: Candida Albicans, and Mold: Aspergillus Niger so that a level of each of these microbial species individually is below an acceptable safe level for human consumption when measured according to United States Pharmacopeia general (USP) Chapter 51, Antimicrobial Effectiveness Testing, at 28 days post exposure to these microbial species occurring via inoculum(s) of

| | | |
|---|---|---|
| Staphylococcus Aureus | 7,000,000 | cfu/g; |
| Pseudomonas Aeruginosa | 49,000,000 | cfu/g; |
| Escheria Coli | 26,500,000 | cfu/g; |
| Yeast - Candida Albicans | 4,000,000 | cfu/g; and |
| Mold - Aspergillus Niger | 650,000 | cfu/g |

applied in accordance with procedures United States Pharmacopeia general (USP) Chapter 51, Antimicrobial Effectiveness Testing; and
an effective amount of a polyene macrolide selected from the group consisting of natamycin, amphotericin B, nystatin, and filipin to provide a preservative action against each of microbial species Staphylococcus Aureus, Pseudomonas Aeruginosa, Escherichia Coli, Yeast: Candida Albicans, and Mold: Aspergillus Niger so that a level of each of these microbial species individually is below an acceptable safe level for human consumption when measured according to United States Pharmacopeia general (USP) Chapter 51, Antimicrobial Effectiveness Testing, at 28 days post exposure to these microbial species occurring via inoculum(s) of

| | | |
|---|---|---|
| Staphylococcus Aureus | 7,000,000 | cfu/g; |
| Pseudomonas Aeruginosa | 49,000,000 | cfu/g; |
| Escheria Coli | 26,500,000 | cfu/g; |
| Yeast - Candida Albicans | 4,000,000 | cfu/g; and |
| Mold - Aspergillus Niger | 650,000 | cfu/g |

applied in accordance with procedures United States Pharmacopeia general (USP) Chapter 51, Antimicrobial Effectiveness Testing for naturally preserving the stevia supplement composition; and
wherein the stevia supplement composition has a minimum shelf life of at least 2 years.

36. An improved stevia supplement composition comprising:
stevia;
water;
an effective amount of vinegar;
an effective amount of citric acid; and
an effective amount of a polyene macrolide selected from the group consisting of amphotericin B, nystatin, natamycin, and filipin.

37. The composition of claim 36, wherein the composition further comprises: a water soluble natural additive and polylysine.

38. The composition of claim 1, wherein the composition further comprises: polylysine.

39. The composition of claim 38, wherein polylysine is present in an amount from about 0.05% to about 5% based on a final total weight of the stevia supplement.

40. The composition of claim 34, wherein the composition further comprises: polylysine.

41. The composition of claim 40, wherein polylysine is present in an amount from about 0.05% to about 5% based on a final total weight of the stevia supplement.
